(19) United States
(12) Patent Application Publication
(10) Pub. No.: US 2026/0147196 A1
(43) Pub. Date: May 28, 2026

(54) VISUAL SYSTEM

(71) Applicant: ZHEJIANG SUNNY OPTICS CO., LTD., Yuyao City (CN)

(72) Inventors: Biran CHEN, Yuyao City (CN); Xiaobin ZHANG, Yuyao City (CN); Lin HUANG, Yuyao City (CN)

(73) Assignee: ZHEJIANG SUNNY OPTICS CO., LTD., Yuyao City (CN)

(21) Appl. No.: 19/253,348

(22) Filed: Jun. 27, 2025

(30) Foreign Application Priority Data
Nov. 26, 2024 (CN) 202411709102.0

(51) Int. Cl. G02B 15/14; G02B 3/04

(52) U.S. Cl. CPC G02B 15/143103; G02B 3/04

(57) ABSTRACT

The disclosure provides a visual system, sequentially including from a first side to a second side along an optical axis: a first lens with a positive refractive power, a reflective polarizing element, a quarter-wave plate, a second lens with a positive refractive power, a partially-reflective element and a third lens with a positive refractive power. A position of the first lens on the optical axis relative to an imaging surface of the second side is fixed, and a distance of the second lens on the optical axis relative to the first lens is adjustable. The visual system satisfies: 1.15≤fg/f2≤1.50 and 1.55<ΔL/Δf<2.1.

### CROSS-REFERENCE TO RELATED APPLICATION

The disclosure claims the priority to Chinese Patent Application No. 202411709102.0, filed with the China National Intellectual Property Administration (CNIPA) on Nov. 26, 2024, which is hereby incorporated by reference in its entirety.

### TECHNICAL FIELD

The disclosure relates to the technical field of optical devices, and in particular to a visual system.

### BACKGROUND

With the development of science and technology, virtual reality devices and/or augmented reality devices are widely used in the fields of gaming, education, medical treatment, engineering, and the like. Visual systems of the virtual reality devices and/or augmented reality devices typically use Fresnel lenses, and such virtual systems using the Fresnel lenses are large in overall length, size, and weight, affecting the experience of a user. Furthermore, such visual systems using the Fresnel lenses do not have a function of adjusting a diopter, such that use requirements of users with different diopters cannot be satisfied.

### SUMMARY

Some embodiments of the disclosure provide a visual system, sequentially including from a first side to a second side along an optical axis: a first lens with a positive refractive power, a reflective polarizing element, a quarter-wave plate, a second lens with a positive refractive power, a partially-reflective element and a third lens with a positive refractive power. A first side surface of the first lens is a convex surface, and a second side surface of the first lens is a flat surface. A second side surface of the second lens is a convex surface. A second side surface of the third lens is a convex surface. A position of the first lens on the optical axis relative to an imaging surface of the second side is fixed, and a distance of the second lens on the optical axis relative to the first lens is adjustable; there are three lenses with refractive powers in the visual system. The visual system satisfies: 1.15≤fg/f2≤1.50 and 1.55<ΔL/Δf<2.1, wherein fg is a combined focal length of the first lens, the reflective polarizing element, and the quarter-wave plate, f2 is an effective focal length of the second lens, ΔL is a movable distance of the second lens when the visual system is switched between a first state and a second state, and Δf is a difference between a total effective focal length when the visual system is in the first state and a total effective focal length when the visual system is in the second state.

In some embodiments, the visual system further satisfies: 6.65<TD/ΔL<7.8, wherein TD is an on-axis distance from the first side surface of the first lens to the second side surface of the third lens, and ΔL is the movable distance of the second lens when the visual system is switched between the first state and the second state.

In some embodiments, the visual system further satisfies: 8.64 mm≤L13≤9.43 mm, wherein L13 is an on-axis distance from the second side surface of the first lens to a first side surface of the third lens.

In some embodiments, the visual system further satisfies: 5.15<EPD/Δf<6.8, wherein EPD is an entrance pupil diameter of the visual system, and Δf is the difference between the total effective focal length when the visual system is in the first state and the total effective focal length when the visual system is in the second state.

In some embodiments, the visual system further satisfies: 2.15 mm<ΔL<2.45 mm, wherein ΔL is the movable distance of the second lens when the visual system is switched between the first state and the second state.

In some embodiments, the visual system further satisfies: 3.0≤fm/CT2≤3.33, wherein fm is the total effective focal length when the visual system is in the first state, and CT2 is a center thickness of the second lens on the optical axis.

In some embodiments, the visual system further satisfies: 5.1< (CT1+CTR+CTQ)/T12n<6.4, wherein CT1 is a center thickness of the first lens on the optical axis, CTR is a center thickness of the reflective polarizing element on the optical axis, CTQ is a center thickness of the quarter-wave plate on the optical axis, and T12n is an on-axis distance from the second side surface of the first lens to a first side surface of the second lens when the visual system is in the second state.

In some embodiments, the visual system further satisfies: 1.07≤CT3/T23n≤1.41, wherein CT3 is a center thickness of the third lens on the optical axis, and T23n is an on-axis distance from the second side surface of the second lens to a first side surface of the third lens when the visual system is in the second state.

In some embodiments, the visual system further satisfies: 7.36≤f1/fn≤10.40, wherein f1 is an effective focal length of the first lens, and fn is the total effective focal length when the visual system is in the second state.

In some embodiments, the visual system further satisfies: −2.6<f3/R6<−1.8, wherein f3 is an effective focal length of the third lens, and R6 is a radius of curvature of the second side surface of the third lens.

In some embodiments, the visual system further satisfies: 5.35<fm/T12m<5.75, wherein fm is the total effective focal length when the visual system is in the first state, and T12m is an on-axis distance from the second side surface of the first lens to a first side surface of the second lens when the visual system is in the first state.

In some embodiments, the visual system further satisfies: −18.65≤R4/(T23m+T23n)≤−12.83, wherein R4 is a radius of curvature of the second side surface of the second lens, T23m is an on-axis distance from the second side surface of the second lens to a first side surface of the third lens when the visual system is in the first state, and T23n is an on-axis distance from the second side surface of the second lens to the first side surface of the third lens when the visual system is in the second state.

In some embodiments, the visual system further satisfies: 3.09≤f2/(fm+fn)≤3.30, wherein f2 is an effective focal length of the second lens, fm is the total effective focal length when the visual system is in the first state, and fn is the total effective focal length when the visual system is in the second state.

In some embodiments, the visual system further satisfies: −11.52≤R4/CT2≤−10.39, wherein R4 is a radius of curvature of the second side surface of the second lens, and CT2 is a center thickness of the second lens on the optical axis.

The visual system provided in the disclosure is able to achieve refraction and reflection of a light path by using the reflective polarizing element, the quarter-wave plate, and the partially-reflective element, and a diopter of the visual system is able to be adjusted by moving the second lens. Furthermore, by respectively constraining fg/f2 and ΔL/Δf within rational ranges, the visual system is able to be switched between the first state and the second state, and the visual system has a good Modulation Transfer Function (MTF) value in different states, such that users with different diopters are able to see clear imaging.

### BRIEF DESCRIPTION OF THE DRAWINGS

Other features, objectives and advantages of the disclosure will become more apparent from a reading of the detailed description of non-limiting embodiments made with reference to the following drawings.

FIG. 1 shows a structural schematic diagram of a visual system in a first state according to Embodiment 1 of the disclosure.

FIG. 2 shows an MTF curve of a visual system in a first state according to Embodiment 1 of the disclosure.

FIG. 3 shows a structural schematic diagram of a visual system in a second state according to Embodiment 1 of the disclosure.

FIG. 4 shows an MTF curve of a visual system in a second state according to Embodiment 1 of the disclosure.

FIG. 5 shows a structural schematic diagram of a visual system in a first state according to Embodiment 2 of the disclosure.

FIG. 6 shows an MTF curve of a visual system in a first state according to Embodiment 2 of the disclosure.

FIG. 7 shows a structural schematic diagram of a visual system in a second state according to Embodiment 2 of the disclosure.

FIG. 8 shows an MTF curve of a visual system in a second state according to Embodiment 2 of the disclosure.

FIG. 9 shows a structural schematic diagram of a visual system in a first state according to Embodiment 3 of the disclosure.

FIG. 10 shows an MTF curve of a visual system in a first state according to Embodiment 3 of the disclosure.

FIG. 11 shows a structural schematic diagram of a visual system in a second state according to Embodiment 3 of the disclosure.

FIG. 12 shows an MTF curve of a visual system in a second state according to Embodiment 3 of the disclosure.

FIG. 13 shows a structural schematic diagram of a visual system in a first state according to Embodiment 4 of the disclosure.

FIG. 14 shows an MTF curve of a visual system in a first state according to Embodiment 4 of the disclosure.

FIG. 15 shows a structural schematic diagram of a visual system in a second state according to Embodiment 4 of the disclosure.

FIG. 16 shows an MTF curve of a visual system in a second state according to Embodiment 4 of the disclosure.

### DETAILED DESCRIPTION OF THE EMBODIMENTS

In order to better understand the disclosure, aspects of the disclosure will be described in greater detail with reference to the drawings. It is to be noted that, these detailed descriptions are merely descriptions of specific embodiments of the disclosure and are not intended to limit the scope of the disclosure in any way. Throughout the specification, the same accompanying symbols refer to the same components.

It is to be noted that, in the specification, expressions such as first, second, etc. are used only to distinguish one feature from another and do not indicate any limitation of the features. Accordingly, without departing from the teachings of the disclosure, the first lens discussed below may also be referred to as a second lens.

In the drawings, the thickness, size and shape of the lens have been slightly exaggerated for ease of illustration. Specifically, a spherical shape or aspheric shape shown in the drawings is shown by some embodiments. That is, the spherical shape or the aspheric shape is not limited to the spherical shape or aspheric shape shown in the drawings. The drawings are for illustrative purposes only and are not strictly to scale.

Herein, a paraxial region refers to a region nearby an optical axis. If the surface of a lens is a convex surface and a position of the convex surface is not defined, it indicates that the lens surface is a convex surface at least in the paraxial region; and if the surface of the lens is a concave surface and a position of the concave surface is not defined, it indicates that the lens surface is a concave surface at least in the paraxial region. The surface of each lens that is closest to a first side (e.g., a human eye side) is referred to as a first side surface of the lens, and the surface of each lens that is closest to a second side (e.g., a display screen side) is referred to as a second side surface of the lens.

It is also to be understood that, the terms “including” and/or “having”, when used in this specification, indicate the presence of the stated features, elements, and/or components, but do not exclude the presence or addition of one or more other features, elements, components, and/or combinations thereof. Furthermore, when describing embodiments of the disclosure, “may” is used to indicate “one or more embodiments of the disclosure”. Moreover, the term “exemplary” is intended to refer to examples or illustrations.

Unless otherwise limited, all terms (including technical terms and scientific terms) used herein have the same meaning as commonly understood by those of ordinary skill in the art to which the disclosure belongs. It should also be understood that terms (e.g., terms defined in commonly used dictionaries) are to be interpreted as with a meaning consistent with their meaning in the context of the relevant technology and will not be interpreted in an idealized or overly formalized sense unless expressly so limited herein.

It is to be noted that the embodiments in the disclosure and the features in the embodiments may be combined with one another without conflict. The disclosure will be described below in detail with reference to the drawings and the embodiments.

The features, principles and other aspects of the disclosure are described in detail below.

Some embodiments of the disclosure provide a visual system, which sequentially includes from a first side to a second side along an optical axis: a first lens, a reflective polarizing element, a quarter-wave plate, a second lens, a partially-reflective element, and a third lens. There are three lenses with refractive powers in the visual system. The refraction and reflection of a light path is able to be achieved by using the reflective polarizing element, the quarter-wave plate, and the partially-reflective element, such that a body length of the visual system is effectively shortened, and a size and weight of the visual system are reduced, thereby achieving the lightweight of the visual system.

In some embodiments, the first lens has a positive refractive power. A first side surface of the first lens is a convex surface, and a second side surface of the first lens is a flat surface.

In some embodiments, the second lens has a positive refractive power. A first side surface of the second lens is a convex surface or a concave surface, and a second side surface of the second lens is a convex surface.

In some embodiments, the third lens has a positive refractive power. A first side surface of the third lens is a concave surface or a flat surface, and a second side surface of the third lens is a convex surface.

In some embodiments, the reflective polarizing element and the quarter-wave plate are attached to each other and attached to the second side surface of the first lens. For example, the reflective polarizing element is at least partially attached to the second side surface of the first lens; and the quarter-wave plate is at least partially attached to a second side surface of the reflective polarizing element. The quarter-wave plate is configured to change a polarization state of light, for example, to convert a circularly polarized light into a linearly polarized light, or to convert the linearly polarized light into the circularly polarized light. The reflective polarizing element is able to reflect light (e.g., the linearly polarized light) of a predetermined direction, and transmit light (e.g., the linearly polarized light) of a direction orthogonal to the predetermined direction.

In some embodiments, the partially-reflective element is located on the second side surface of the second lens, and is at least partially fitted to the second side surface of the second lens. The partially-reflective element has a semi-transmissive and semi-reflective effect on the light. By providing the partially-reflective element on the second side surface of the second lens, and in combination with the reflective polarizing element and the quarter-wave plate, the light is able to achieve multiple refraction and reflection, thereby effectively reducing the body length of the visual system.

In some embodiments, the visual system further includes a diaphragm, and the diaphragm is arranged between the first side and the first lens. An image light from the second side is transmitted to the diaphragm after being refracted and reflected for a plurality of times by the third lens, the partially-reflective element, the second lens, the quarter-wave plate, the reflective polarizing element, the first lens, etc., and finally forms a virtual image at a predetermined position. As an example, the diaphragm is a pupil of a user.

In some embodiments, the second side of the visual system is provided with an imaging surface. A display screen is provided on the imaging surface. An image light from the display screen sequentially passes through the third lens, the second lens, and the quarter-wave plate to reach the reflective polarizing element, and then is reflected at the reflective polarizing element to form a first reflected image light. The first reflected image light passes through the quarter-wave plate and the second lens and reaches the partially-reflective element on the second side surface of the second lens, and then is reflected at the partially-reflective element to form a second reflected image light. The second reflected image light sequentially passes through the second lens, the quarter-wave plate, the reflective polarizing element, the first lens to the diaphragm (e.g., the pupil of the user), and finally images at the predetermined position. The visual system provided in the disclosure folds a required optical path by means of combining light reflection and refraction without affecting projection quality, such that a body length of the visual system is effectively shortened.

In some embodiments, positions of the first lens and the third lens on the optical axis relatively to the imaging surface are fixed. The second lens is able to move along the optical axis relatively to the first lens, that is, a distance of the second lens on the optical axis relatively to the first lens is adjustable. By moving the second lens, the visual system is able to be switched between a first state and a second state to adjust a diopter of the visual system, such that use requirements of users with different diopters are satisfied, for example, the use requirements of the users with the diopters being +2D to −5D are satisfied.

When the visual system is in the first state, the diopter of the visual system is +2D, which is suitable for a user with the diopter being +2D; and when the visual system is in the second state, the diopter of the visual system is −5D, which is suitable for a user with the diopter being −5D. When a sign of the diopter is a negative sign, it indicates that the user belongs to myopic users; when the sign of the diopter is a positive sign, it indicates that the user belongs to hyperopic users; and a specific numerical value of the diopter indicates a refractive diopter. For example, that the diopter is +1D indicates that a hyperopic degree of the user is about 100 degrees; and that the diopter is −1D indicates that a myopic degree of the user is about 100 degrees.

It is to be noted that, the visual system has not only two states (e.g., the first state and the second state), the visual system is also able to have at least one of other states in addition to the first state and the second state. The diopter of the visual system is between +2D and −5D when the visual system is in other states, and the number of states that the visual system has is not specifically limited in the disclosure.

In some embodiments, virtual image distances of the visual system in the first state and the second state are different. The virtual image distance VID is, for example, an on-axis distance between a virtual image formed by image light from the second side at a predetermined position and the diaphragm. VID=1000/diopter.

In some embodiments, the visual system satisfies: 1.15≤fg/f2≤1.50 and 1.55<ΔL/Δf<2.1, wherein fg is a combined focal length of the first lens, the reflective polarizing element, and the quarter-wave plate, f2 is an effective focal length of the second lens, ΔL is a movable distance of the second lens when the visual system is switched between the first state and the second state, and Δf is a difference between a total effective focal length when the visual system is in the first state and a total effective focal length when the visual system is in the second state. By respectively constraining fg/f2 and ΔL/Δf within rational ranges, the visual system is able to be switched between the first state and the second state to adjust the diopter of the visual system. For example, the diopter of the visual system is adjusted between +2D and −5D, and the visual system has a good MTF value in different states, such that the users (e.g., the users with the diopters being +2D to −5D) with different diopters are able to see clear imaging.

In some embodiments, the visual system satisfies: 6.65<TD/ΔL<7.8, wherein TD is an on-axis distance from the first side surface of the first lens to the second side surface of the third lens, and ΔL is the movable distance of the second lens when the visual system is switched between the first state and the second state. By controlling the above conditional expression, the body length of the visual system and the movable distance of the second lens are able to be constrained, such that the second lens has a large movable distance during the adjustment of the diopter of the visual system, and a structure design space of the visual system is larger, thereby facilitating improvement of the processability of the visual system.

In some embodiments, the visual system satisfies: 8.64 mm≤L13≤9.43 mm, wherein L13 is an on-axis distance from the second side surface of the first lens to a first side surface of the third lens. By constraining the on-axis distance from the second side surface of the first lens to the first side surface of the third lens within a rational range, the second lens is able to have an enough movable space during the adjustment of the diopter of the visual system.

In some embodiments, the visual system satisfies: 5.15<EPD/Δf<6.8, wherein EPD is an entrance pupil diameter of the visual system; and Δf is a difference between a total effective focal length when the visual system is in the first state and a total effective focal length when the visual system is in the second state. By controlling the above conditional expression, the difference between the total effective focal length when the visual system is in the first state and the total effective focal length when the visual system is in the second state is constrained within a rational range, the diopter of the visual system is adjusted (e.g., the diopter is adjusted between +2D and −5D), and the users (e.g., the users with the diopters being +2D to −5D) with different diopters are able to see clear imaging.

In some embodiments, the visual system satisfies: 2.15 mm<ΔL<2.45 mm, wherein ΔL is the movable distance of the second lens when the visual system is switched between the first state and the second state. By constraining the movable distance of the second lens when the visual system is switched between the first state and the second state within a rational range, the second lens is able to have an enough movable distance during the adjustment of the diopter of the visual system, and the body length of the visual system is able to be reduced as much as possible, thereby facilitating the miniaturization of the visual system.

In some embodiments, the visual system satisfies: 3.0≤fm/CT2≤3.33, wherein fm is the total effective focal length when the visual system is in the first state, and CT2 is a center thickness of the second lens on the optical axis. By constraining a ratio of the total effective focal length when the visual system is in the first state to the center thickness of the second lens on the optical axis within a rational range, the entire visual system is able to be lighter and thinner, and a movement space required by the second lens during the adjustment of the diopter of the visual system is reduced.

In some embodiments, the visual system satisfies: 5.1< (CT1+CTR+CTQ)/T12n<6.4, wherein CT1 is a center thickness of the first lens on the optical axis; CTR is a center thickness of the reflective polarizing element on the optical axis; CTQ is a center thickness of the quarter-wave plate on the optical axis; and T12n is an on-axis distance from the second side surface of the first lens to a first side surface of the second lens when the visual system is in the second state. When the visual system is in the second state, the on-axis distance from the second side surface of the first lens to the first side surface of the second lens is minimum. By controlling the above conditional expression, the center thicknesses of the first lens, reflective polarizing element, and quarter-wave plate are able to be constrained, and the body length of the visual system is reduced, thereby achieving the miniaturization of the visual system. Furthermore, the on-axis distance from the second side surface of the first lens to the first side surface of the second lens when the visual system is in the second state is also able to be limited to avoid interference between the first lens and the second lens, and there is a certain structure design space between the first lens and the second lens.

In some embodiments, the visual system satisfies: 1.07≤CT3/T23n≤1.41, wherein CT3 is a center thickness of the third lens on the optical axis; and T23n is an on-axis distance from the second side surface of the second lens to the first side surface of the third lens when the visual system is in the second state. By controlling the above conditional expression, the second lens is able to have an enough movable space during the adjustment of the diopter of the visual system, and the distance between the second lens and the third lens is reduced as much as possible, the distance between the first lens and the third lens is reduced, and the body length of the visual system is reduced, thereby achieving the miniaturization of the visual system.

In some embodiments, the visual system satisfies: 7.36≤f1/fn≤10.40, wherein f1 is an effective focal length of the first lens, and fn is the total effective focal length when the visual system is in the second state. By constraining a ratio of the effective focal length of the first lens to the total effective focal length when the visual system is in the second state within a rational range, light is able to be better converged by the first lens, such that a sensitivity tolerance of the visual system is reduced while an imaging requirement is satisfied.

In some embodiments, the visual system further satisfies: −2.6<f3/R6<−1.8, wherein f3 is an effective focal length of the third lens, and R6 is a radius of curvature of the second side surface of the third lens. By constraining a ratio of the effective focal length of the third lens to the radius of curvature of the second side surface of the third lens within a rational range, a change in an angle when the light passes through the first side surface and second side surface of the third lens is within a certain range, thereby increasing the relative illumination of light with a large field of view.

In some embodiments, the visual system satisfies: 5.35<fm/T12m<5.75, wherein fm is the total effective focal length when the visual system is in the first state, and T12m is an on-axis distance from the second side surface of the first lens to the first side surface of the second lens when the visual system is in the first state. By controlling the above conditional expression, the second lens is able to have an enough movable space during the adjustment of the diopter of the visual system, and the distance between the first lens and the second lens is reduced as much as possible, the distance between the first lens and the third lens is reduced, and the body length of the visual system is reduced, thereby achieving a miniaturization of the visual system.

In some embodiments, the visual system satisfies: −18.65≤R4/(T23m+T23n)≤−12.83, wherein R4 is a radius of curvature of the second side surface of the second lens, T23m is an on-axis distance from the second side surface of the second lens to the first side surface of the third lens when the visual system is in the first state, and T23n is an on-axis distance from the second side surface of the second lens to the first side surface of the third lens on the optical axis when the visual system is in the second state. By controlling the above conditional expression, a shape of the second lens and the distance between the second lens and the first lens and the third lens are able to be constrained, such that the processability of the second lens is improved, and the body length of the visual system is reduced, thereby achieving the miniaturization of the visual system.

In some embodiments, the visual system satisfies: 3.09≤f2/(fm+fn)≤3.30, wherein f2 is an effective focal length of the second lens, fm is the total effective focal length when the visual system is in the first state, and fn is the total effective focal length when the visual system is in the second state. By constraining a ratio of the effective focal length of the second lens to a sum of the total effective focal lengths when the visual system is in the first state and the second state within a rational range, light is able to be better converged by the second lens, such that a sensitivity tolerance of the visual system is reduced while an imaging requirement is satisfied.

In some embodiments, the visual system further satisfies: −11.52≤R4/CT2≤−10.39, wherein R4 is a radius of curvature of the second side surface of the second lens, and CT2 is a center thickness of the second lens on the optical axis. By constraining the radius of curvature of the second side surface of the second lens and the center thickness of the second lens on the optical axis within rational ranges, the overall shape of the second lens is able to be constrained, such that a thickness ratio of the second lens is constrained, thereby improving the processability of the second lens.

The visual system according to the above embodiments of the disclosure adopts a plurality of lens, for example, three lenses described above. By rationally allocating parameters of the reflective polarizing element, quarter-wave plate, and lenses, the body length of the visual system is able to be reduced, the imaging quality of the visual system is improved, and the diopter of the visual system is also able to be adjusted, such that the users with the diopters being +2D to −5D are able to see clear imaging. Through the above configured visual system with the characteristics of adjustment of the diopter, lightweight, good imaging quality, etc. use requirements of portable electronic products in projection scenarios.

In some embodiments of the disclosure, at least one of surfaces of the first lens, the second lens, and the third lens is an aspheric surface. An aspheric lens has a characteristic that a curvature keeps changing from the center of the lens to the periphery of the lens. Unlike a spherical lens with a constant curvature from the center of the lens to the periphery of the lens, the aspheric lens has the characteristic of a better radius of curvature and the advantages of improving distortions and improving astigmatic aberrations. By using the aspheric lens, aberrations during imaging may be eliminated as much as possible, thereby improving the imaging quality.

Some other embodiments of the disclosure provide a visual system, sequentially including from a first side to a second side along an optical axis: a first lens with a positive refractive power, a reflective polarizing element, a quarter-wave plate, a second lens with a positive refractive power, a partially-reflective element, and a third lens with a positive refractive power. A first side surface of the first lens is a convex surface, and a second side surface is a flat surface. A second side surface of the second lens is a convex surface. A second side surface of the third lens is a convex surface. A position of the first lens on the optical axis relative to an imaging surface of the second side is fixed, and a distance of the second lens on the optical axis relative to the first lens is adjustable. There are three lenses with refractive powers in the visual system.

The visual system satisfies: 1.15≤fg/f2≤1.50 and 8.64 mm≤L13≤9.43 mm, wherein fg is a combined focal length of the first lens, the reflective polarizing element, and the quarter-wave plate, f2 is an effective focal length of the second lens, and L13 is an on-axis distance from the second side surface of the first lens to a first side surface of the third lens. The visual system provided in the disclosure is able to achieve the refraction and reflection of a light path by using the reflective polarizing element, the quarter-wave plate, and the partially-reflective element, and the visual system is able to be switched between the first state and the second state to adjust the diopter of the visual system by moving the second lens, thereby achieve the adjustment of the diopter of the visual system. Furthermore, by respectively constraining fg/f2 and L13 within rational ranges, the second lens is able to have an enough movable space during the adjustment of the diopter of the visual system, and the visual system has a good MTF value in different states, such that the users (e.g., the users with the diopters being +2D to −5D) with different diopters can see clear imaging.

However, those skilled in the art should know that the number of the lenses forming the visual system is able to be changed without departing from the technical solutions claimed in the disclosure to achieve each result and advantage described in the specification.

Specific embodiments of the visual system applicable to the above embodiments are further described below with reference to the drawings.

### Embodiment 1

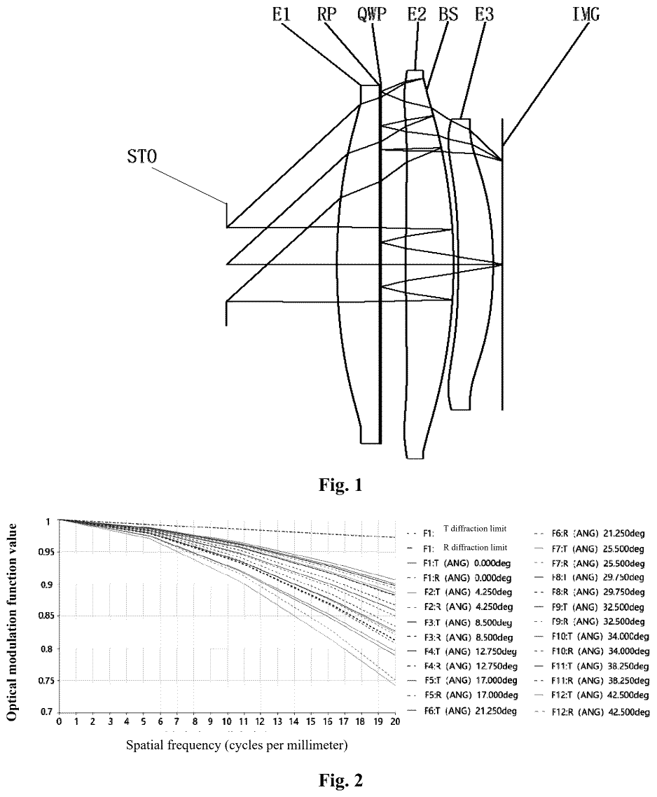

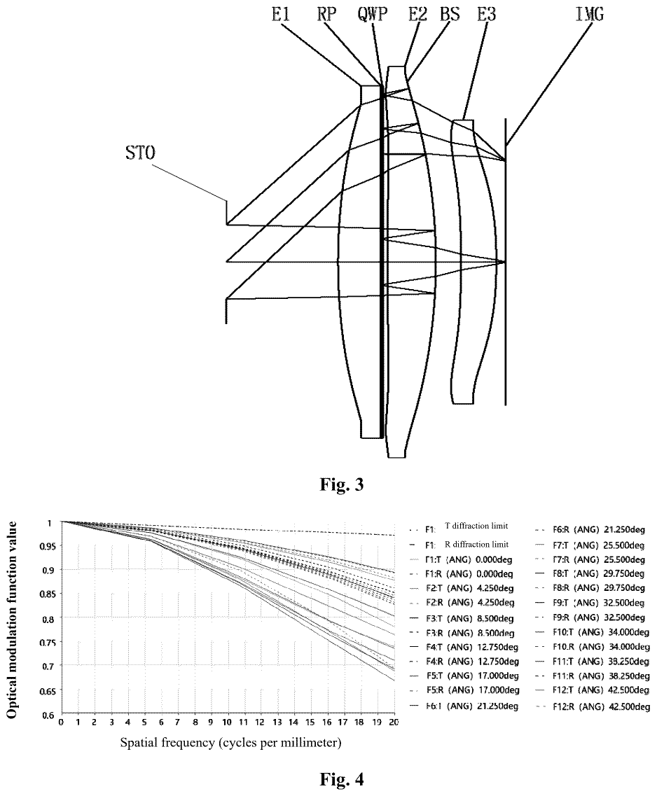

A visual system in Embodiment 1 of the disclosure is described below with reference to FIG. 1, FIG. 2, FIG. 3, and FIG. 4.

As shown in FIG. 1 and FIG. 3, the visual system includes a first lens E1, a reflective polarizing element RP, a quarter-wave plate QWP, a second lens E2, a partially-reflective element BS, and a third lens E3, which are sequentially arranged from a first side to a second side along an optical axis. A diaphragm STO is located on an object side of the first lens E1. In the embodiment, the first side refers to a human eye side, and the second side refers to a display screen side.

The first lens E1 has a positive refractive power, a first side surface S1 thereof is a convex surface and a second side surface S2 thereof is a flat surface. The second lens E2 has a positive refractive power, with a first side surface S3 thereof is a convex surface, and a second side surface S4 thereof is a convex surface. The third lens E3 has a positive refractive power, with a first side surface S5 thereof is a concave surface, and a second side surface S6 thereof is a convex surface. The reflective polarizing element RP and the quarter-wave plate QWP are attached to the second side surface S2 of the first lens E1. The partially-reflective element BS is attached to the second side surface S4 of the second lens E2. It is to be noted that, surfaces S1, S2, S3, S4, S5 and S6 are not shown in FIG. 1 and FIG. 3.

In the embodiment, the second side of the visual system is provided with an imaging surface IMG, and a display screen is, for example, provided on the imaging surface IMG. As shown in FIG. 1 and FIG. 3, image light from the imaging surface IMG sequentially passes through the third lens E3, the second lens E2, and the quarter-wave plate QWP, reaches the reflective polarizing element RP, and then is subjected to a first reflection at the reflective polarizing element RP. The first reflected light passes through the quarter-wave plate QWP and the second lens E2 and reaches the partially-reflective element BS located on the second side surface of the second lens, and then is subjected to a second reflection at the partially-reflective element BS. The second reflected light sequentially passes through the second lens E2, the quarter-wave plate QWP, the reflective polarizing element RP, the first lens E1 to the diaphragm, and finally images at the predetermined position. For example, the light of the visual system that is reflected twice is finally projected to the pupil of a user.

Table 1 shows a basic structure parameter table of the visual system in Embodiment 1; and radius of curvature and thickness/distance are all millimeters (mm). The image light from the imaging surface IMG passes the elements according to a sequence from a serial number 15 to a serial number 1, and is finally projected to the pupil of the user.

TABLE 1

| | | | Radius | | Material | | | |
|---|---|---|---|---|---|---|---|---|
| Serial | | Surface | of | Thickness/ | Refractive | Abbe | Refraction/ | Conic |
| number | Element | type | curvature | distance | index | number | Reflection | coefficient |
| | | Spherical | Infinite | W1 | | | Refraction | |
| 1 | Diaphragm | Spherical | Infinite | 12.0000 | | | Refraction | |
| 2 | First lens | Aspheric | 62.5763 | 4.5563 | 1.548 | 56.30 | Refraction | −6.7646 |
| 3 | Reflective | Spherical | Infinite | 0.1180 | 1.495 | 57.47 | Refraction | |
| | polarizing | | | | | | | |
| | element | | | | | | | |
| 4 | Quarter- | Spherical | Infinite | 0.1340 | 1.495 | 57.47 | Refraction | |
| | wave | | | | | | | |
| | plate | | | | | | | |
| 5 | | Spherical | Infinite | W2 | | | Refraction | |
| 6 | Second | Aspheric | 650.7911 | 5.1957 | 1.548 | 56.30 | Refraction | 92.1947 |
| | lens | | | | | | | |
| 7 | Partially- | Aspheric | −59.4845 | −5.1957 | 1.548 | 56.30 | Reflection | −5.8628 |
| | reflective | | | | | | | |
| | element | | | | | | | |
| 8 | | Aspheric | 650.7911 | −W2 | | | Refraction | 92.1947 |
| 9 | | Spherical | Infinite | −0.1340 | 1.495 | 57.47 | Refraction | |
| 10 | Reflective | Spherical | Infinite | 0.1340 | 1.495 | 57.47 | Reflection | |
| | polarizing | | | | | | | |
| | element | | | | | | | |
| 11 | | Spherical | Infinite | W2 | | | Refraction | |
| 12 | Second | Aspheric | 650.7911 | 5.1957 | 1.548 | 56.30 | Refraction | 92.1947 |
| | lens | | | | | | | |
| 13 | | Aspheric | −59.4845 | W3 | | | Refraction | −5.8628 |
| 14 | Third lens | Aspheric | −158.3642 | 3.8060 | 1.548 | 56.30 | Refraction | 99.0000 |
| 15 | | Aspheric | −47.8906 | 1.0000 | | | Refraction | 8.7241 |
| | Imaging | Spherical | Infinite | 0.0000 | | | Refraction | |
| | surface | | | | | | | |

In the embodiment, the first side surface S1 of the first lens E1, the first side surface S3 and the second side surface S4 of the second lens E2, and the first side surface S5 and the second side surface S6 of the third lens E3 are all aspheric surfaces, and the surface types of various aspheric surfaces may be limited by using, but not limited to, the following aspheric formula.

$$x = \frac{c {h}^{2}}{1 + \sqrt{1 - ( k + 1 ) {c}^{2} {h}^{2}}} + \sum {Aih}^{i} \qquad ( 1 )$$

Wherein x is a vector height of a distance between the aspheric surface and a vertex of the aspheric surface when the aspheric surface is located at a position with the height h in an optical axis direction; c is a paraxial curvature of the aspheric surface, c=1/R, i.e., the paraxial curvature c is a reciprocal of the radius of curvature R in Table 1; k is a conic coefficient; and Ai is a correction coefficient for an i-th order of the aspheric surface. Table 2 provides high-order term coefficients A4, A6, A8, A10, A12, A14, A16, A18, and A20 applied to surfaces S1, S3, S4, S5, and S6 in Embodiment 1.

TABLE 2

| Surface | | | | | | | | | |
|---|---|---|---|---|---|---|---|---|---|
| number | A4 | A6 | A8 | A10 | A12 | A14 | A16 | A18 | A20 |
| S1 | −2.4290E−06 | 8.5145E−08 | −3.7998E−10 | 8.4167E−13 | −9.6417E−16 | 0.0000E+00 | 0.0000E+00 | 0.0000E+00 | 0.0000E+00 |
| S3 | 9.1121E−06 | −7.5641E−08 | 3.9449E−11 | 2.5182E−13 | −1.3614E−16 | 0.0000E+00 | 0.0000E+00 | 0.0000E+00 | 0.0000E+00 |
| S4 | −2.4825E−07 | −9.9591E−09 | −1.4896E−11 | 9.7420E−14 | −4.2552E−17 | 0.0000E+00 | 0.0000E+00 | 0.0000E+00 | 0.0000E+00 |
| S5 | −5.6259E−05 | 2.2618E−07 | 4.5696E−10 | −3.0363E−12 | 7.8493E−15 | 0.0000E+00 | 0.0000E+00 | 0.0000E+00 | 0.0000E+00 |
| S6 | −5.1283E−05 | 3.1903E−07 | −2.1205E−10 | −8.1681E−13 | 9.7622E−15 | 0.0000E+00 | 0.0000E+00 | 0.0000E+00 | 0.0000E+00 |

In the embodiment, the visual system has the first state (as shown in FIG. 1) and the second state (as shown in FIG. 3). A value of a virtual image distance of the visual system is W1, a value of a spacing distance between the quarter-wave plate and the second lens is W2, and a value of a spacing distance between the second lens and the third lens is W3. W1, W2, and W3 are variables, and are able to vary with the state of the visual system.

Table 3 shows values of W1, W2, and W3 in different states of the visual system in Embodiment 1.

TABLE 3

| Status | W1(mm) | W2(mm) | W3(mm) |
|---|---|---|---|
| First state | 500.0000 | 2.6900 | 0.5000 |
| Second state | −200.0000 | 0.5000 | 2.6900 |

FIG. 2 shows an MTF curve of a visual system in a first state according to Embodiment 1. FIG. 4 shows an MTF curve of a visual system in a second state according to Embodiment 1. According to FIG. 2 and FIG. 4, it is seen that, the visual system provided in Embodiment 1 in the first state and the second state is able to achieve good imaging quality.

### Embodiment 2

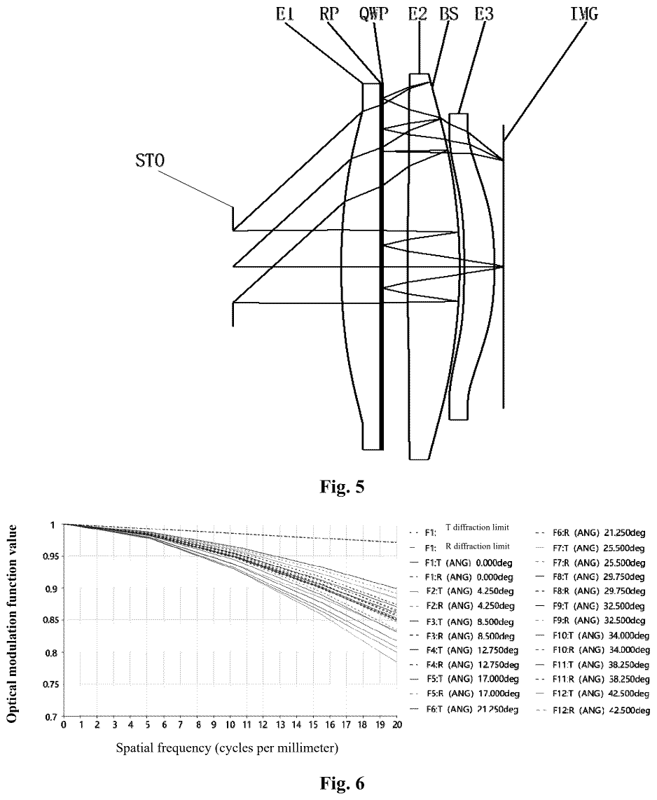

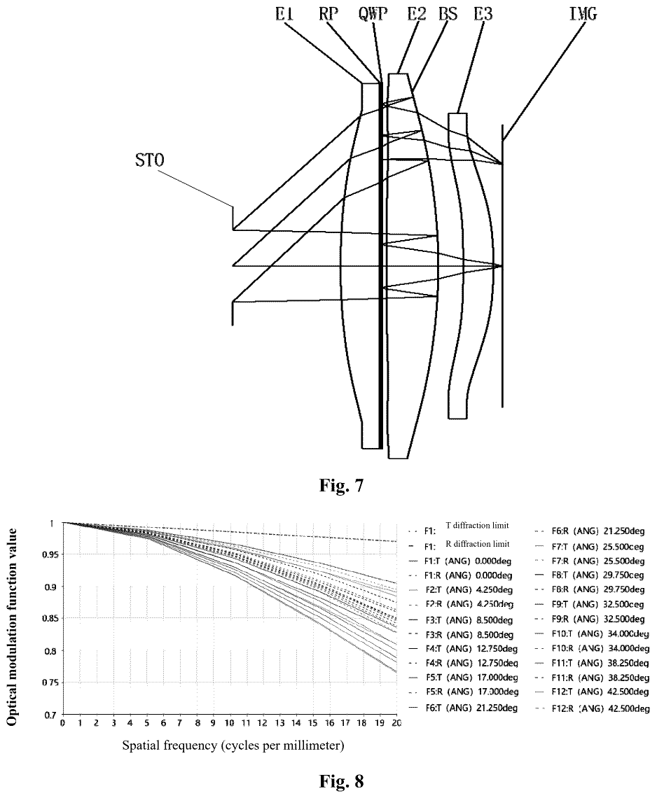

A visual system in Embodiment 2 of the disclosure is described below with reference to FIG. 5, FIG. 6, FIG. 7, and FIG. 8.

As shown in FIG. 5 and FIG. 7, the visual system includes a first lens E1, a reflective polarizing element RP, a quarter-wave plate QWP, a second lens E2, a partially-reflective element BS, and a third lens E3, which are sequentially arranged from a first side to a second side along an optical axis. A diaphragm STO is located on an object side of the first lens E1. In the embodiment, the first side refers to a human eye side, and the second side refers to a display screen side.

The first lens E1 has a positive refractive power, with a first side surface S1 thereof is a convex surface and a second side surface S2 thereof is a flat surface. The second lens E2 has a positive refractive power, with a first side surface S3 thereof is a convex surface, and a second side surface S4 thereof is a convex surface. The third lens E3 has a positive refractive power, with a first side surface S5 thereof is a concave surface, and a second side surface S6 thereof is a convex surface. The reflective polarizing element RP and the quarter-wave plate QWP are attached to the second side surface S2 of the first lens E1. The partially-reflective element BS is attached to the second side surface S4 of the second lens E2. It is to be noted that, surfaces S1, S2, S3, S4, S5 and S6 are not shown in FIG. 5 and FIG. 7.

In the embodiment, the second side of the visual system is provided with an imaging surface IMG, and a display screen is, for example, provided on the imaging surface IMG. As shown in FIG. 5 and FIG. 7, image light from the imaging surface IMG sequentially passes through the third lens E3, the second lens E2, and the quarter-wave plate QWP, reaches the reflective polarizing element RP, and then is subjected to a first reflection at the reflective polarizing element RP. The first reflected light passes through the quarter-wave plate QWP and the second lens E2 and reaches the partially-reflective element BS located on the second side surface of the second lens, and then is subjected to a second reflection at the partially-reflective element BS. The second reflected light sequentially passes through the second lens E2, the quarter-wave plate QWP, the reflective polarizing element RP, the first lens E1 to the diaphragm, and finally images at the predetermined position. For example, the light of the visual system that is reflected twice is finally projected to the pupil of a user.

Table 4 shows a basic structure parameter table of the visual system in Embodiment 2; and radius of curvature and thickness/distance are all millimeters (mm). The image light from the imaging surface IMG passes the elements according to a sequence from a serial number 15 to a serial number 1, and is finally projected to the pupil of the user.

TABLE 4

| | | | | | Material | | | |
|---|---|---|---|---|---|---|---|---|
| Serial | | | Radius of | Thickness/ | Refractive | Abbe | Refraction/ | Conic |
| number | Element | Surface type | curvature | distance | index | number | Reflection | coefficient |
| | | Spherical | Infinite | W1 | | | Refraction | |
| 1 | Diaphragm | Spherical | Infinite | 12.0000 | | | Refraction | |
| 2 | First lens | Aspheric | 67.3619 | 4.3553 | 1.548 | 56.30 | Refraction | −1.3330 |
| 3 | Reflective | Spherical | Infinite | 0.1180 | 1.495 | 57.47 | Refraction | |
| | polarizing | | | | | | | |
| | element | | | | | | | |
| 4 | Quarter- | Spherical | Infinite | 0.1340 | 1.495 | 57.47 | Refraction | |
| | wave plate | | | | | | | |
| 5 | | Spherical | Infinite | W2 | | | Refraction | |
| 6 | Second lens | Aspheric | 2543.9949 | 5.7600 | 1.548 | 56.30 | Refraction | 99.0000 |
| 7 | Partially- | Aspheric | −59.8217 | −5.7600 | 1.548 | 56.30 | Reflection | −7.3212 |
| | reflective | | | | | | | |
| | element | | | | | | | |
| 8 | | Aspheric | 2543.9949 | −W2 | | | Refraction | 99.0000 |
| 9 | | Spherical | Infinite | −0.1340 | 1.495 | 57.47 | Refraction | |
| 10 | Reflective | Spherical | Infinite | 0.1340 | 1.495 | 57.47 | Reflection | |
| | polarizing | | | | | | | |
| | element | | | | | | | |
| 11 | | Spherical | Infinite | W2 | | | Refraction | |
| 12 | Second lens | Aspheric | 2543.9949 | 5.7600 | 1.548 | 56.30 | Refraction | 99.0000 |
| 13 | | Aspheric | −59.8217 | W3 | | | Refraction | −7.3212 |
| 14 | Third lens | Aspheric | −162.0073 | 3.3591 | 1.548 | 56.30 | Refraction | 99.0000 |
| 15 | | Aspheric | −45.3851 | 1.0000 | | | Refraction | 3.0203 |
| | Imaging | Spherical | Infinite | 0.0000 | | | Refraction | |
| | surface | | | | | | | |

In the embodiment, the first side surface S1 of the first lens E1, the first side surface S3 and the second side surface S4 of the second lens E2, and the first side surface S5 and the second side surface S6 of the third lens E3 are all aspheric surfaces. Table 5 provides high-order coefficients A4, A6, A8, A10, A12, A14, A16, A18, and A20 applied to surfaces S1, S3, S4, S5, and S6 in Embodiment 2.

TABLE 5

| Surface | | | | | |
|---|---|---|---|---|---|
| number | A4 | A6 | A8 | A10 | A12 |
| S1 | −4.1213E−06 | 9.1886E−08 | −4.4712E−10 | 1.0119E−12 | −7.1868E−16 |
| S3 | 2.2218E−05 | −1.4167E−07 | 1.5957E−10 | 4.4994E−13 | −6.1740E−16 |
| S4 | 1.9785E−06 | −1.4811E−08 | −3.8796E−11 | 2.2860E−13 | −1.9977E−16 |
| S5 | −1.1386E−04 | 5.3595E−07 | 8.3880E−10 | −8.0735E−12 | 9.0532E−15 |
| S6 | −1.2430E−04 | 8.7665E−07 | −7.3836E−10 | −6.8129E−12 | 1.0913E−14 |

| Surface | | | | |
|---|---|---|---|---|
| number | A14 | A16 | A18 | A20 |
| S1 | −2.8375E−18 | 5.3340E−21 | 0.0000E+00 | 0.0000E+00 |
| S3 | −3.0075E−19 | −4.8006E−23 | 0.0000E+00 | 0.0000E+00 |
| S4 | 9.1843E−20 | −3.3541E−22 | 0.0000E+00 | 0.0000E+00 |
| S5 | −1.9171E−18 | 5.8508E−20 | 0.0000E+00 | 0.0000E+00 |
| S6 | −1.0592E−18 | 8.9915E−20 | 0.0000E+00 | 0.0000E+00 |

In the embodiment, the visual system has the first state (as shown in FIG. 5) and the second state (as shown in FIG. 7). W1, W2, and W3 are variables, and is able to vary with the state of the visual system.

Table 6 shows values of W1, W2, and W3 in different states of the visual system in Embodiment 2.

TABLE 6

| Status | W1(mm) | W2(mm) | W3(mm) |
|---|---|---|---|
| First state | 500.0000 | 2.7736 | 0.5000 |
| Second state | −200.0000 | 0.5000 | 2.7736 |

FIG. 6 shows an MTF curve of a visual system in a first state according to Embodiment 2. FIG. 8 shows an MTF curve of a visual system in a second state according to Embodiment 2. According to FIG. 6 and FIG. 8, it is seen that, the visual system provided in Embodiment 2 in the first state and the second state is able to achieve good imaging quality.

### Embodiment 3

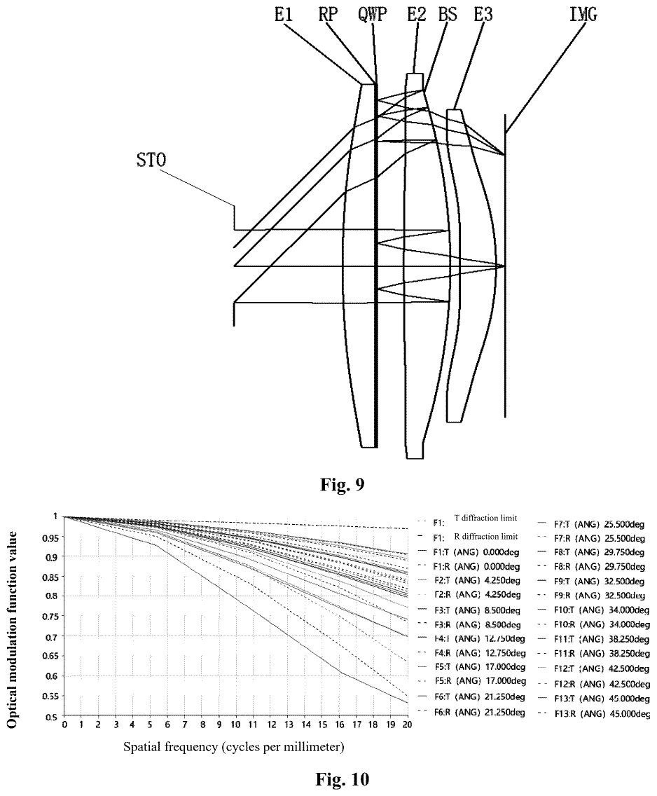

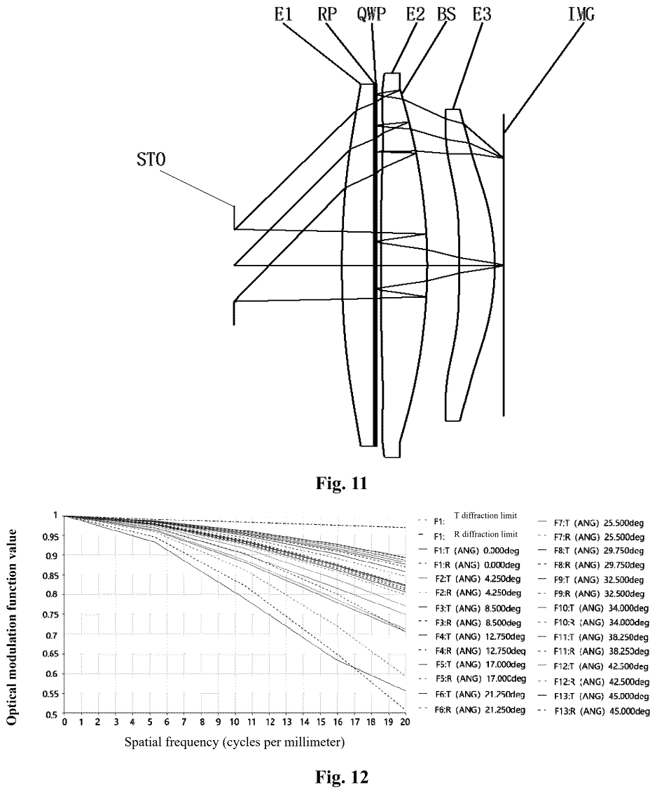

A visual system in Embodiment 3 of the disclosure is described below with reference to FIG. 9, FIG. 10, FIG. 11, and FIG. 12.

As shown in FIG. 9 and FIG. 11, the visual system includes a first lens E1, a reflective polarizing element RP, a quarter-wave plate QWP, a second lens E2, a partially-reflective element BS, and a third lens E3, which are sequentially arranged from a first side to a second side along an optical axis. A diaphragm STO is located on an object side of the first lens E1. In the embodiment, the first side refers to a human eye side, and the second side refers to a display screen side.

The first lens E1 has a positive refractive power, with a first side surface S1 thereof is a convex surface and a second side surface S2 thereof is a flat surface. The second lens E2 has a positive refractive power, with a first side surface S3 thereof is a concave surface, and a second side surface S4 thereof is a convex surface. The third lens E3 has a positive refractive power, with a first side surface S5 thereof is a concave surface, and a second side surface S6 thereof is a convex surface. The reflective polarizing element RP and the quarter-wave plate QWP are attached to the second side surface S2 of the first lens E1. The partially-reflective element BS is attached to the second side surface S4 of the second lens E2. It is to be noted that, surfaces S1, S2, S3, S4, S5 and S6 are not shown in FIG. 9 and FIG. 11.

In the embodiment, the second side of the visual system is provided with an imaging surface IMG, and a display screen is, for example, provided on the imaging surface IMG. As shown in FIG. 9 and FIG. 11, image light from the imaging surface IMG sequentially passes through the third lens E3, the second lens E2, and the quarter-wave plate QWP, reaches the reflective polarizing element RP, and then is subjected to a first reflection at the reflective polarizing element RP. The first reflected light passes through the quarter-wave plate QWP and the second lens E2 and reaches the partially-reflective element BS located on the second side surface of the second lens, and then is subjected to a second reflection at the partially-reflective element BS. The second reflected light sequentially passes through the second lens E2, the quarter-wave plate QWP, the reflective polarizing element RP, the first lens E1 to the diaphragm, and finally images at the predetermined position. For example, the light of the visual system that is reflected twice is finally projected to the pupil of a user.

Table 7 shows a basic structure parameter table of the visual system in Embodiment 3; and radius of curvature and thickness/distance are all millimeters (mm). The image light from the imaging surface IMG passes the elements according to a sequence from a serial number 15 to a serial number 1, and is finally projected to the pupil of the user.

TABLE 7

| | | | | | Material | | | |
|---|---|---|---|---|---|---|---|---|
| Serial | | | Radius of | Thickness/ | Refractive | Abbe | Refraction/ | Conic |
| number | Element | Surface type | curvature | distance | index | number | Reflection | coefficient |
| | | Spherical | Infinite | W1 | | | Refraction | |
| 1 | Diaphragm | Spherical | Infinite | 12.0000 | | | Refraction | |
| 2 | First lens | Aspheric | 88.9098 | 3.5981 | 1.548 | 56.30 | Refraction | −24.7583 |
| 3 | Reflective | Spherical | Infinite | 0.1180 | 1.495 | 57.47 | Refraction | |
| | polarizing | | | | | | | |
| | element | | | | | | | |
| 4 | Quarter- | Spherical | Infinite | 0.1340 | 1.495 | 57.47 | Refraction | |
| | wave plate | | | | | | | |
| 5 | | Spherical | Infinite | W2 | | | Refraction | |
| 6 | Second lens | Aspheric | −4347782.2049 | 5.1476 | 1.548 | 56.30 | Refraction | −1.9585E+12 |
| 7 | Partially- | Aspheric | −59.2948 | −5.1476 | 1.548 | 56.30 | Reflection | −6.1681 |
| | reflective | | | | | | | |
| | element | | | | | | | |
| 8 | | Aspheric | −4347782.2049 | −W2 | | | Refraction | −1.9585E+12 |
| 9 | | Spherical | Infinite | −0.1340 | 1.495 | 57.47 | Refraction | |
| 10 | Reflective | Spherical | Infinite | 0.1340 | 1.495 | 57.47 | Reflection | |
| | polarizing | | | | | | | |
| | element | | | | | | | |
| 11 | | Spherical | Infinite | W2 | | | Refraction | |
| 12 | Second lens | Aspheric | 4347782.2049 | 5.1476 | 1.548 | 56.30 | Refraction | −1.9585E+12 |
| 13 | | Aspheric | −59.2948 | W3 | | | Refraction | −6.1681 |
| 14 | Third lens | Aspheric | −4736.7241 | 3.9717 | 1.548 | 56.30 | Refraction | −1.3965E+12 |
| 15 | | Aspheric | −27.0247 | 1.0000 | | | Refraction | −33.2444 |
| | Imaging | Spherical | Infinite | 0.0000 | | | Refraction | |
| | surface | | | | | | | |

In the embodiment, the first side surface S1 of the first lens E1, the first side surface S3 and the second side surface S4 of the second lens E2, and the first side surface S5 and the second side surface S6 of the third lens E3 are all aspheric surfaces. Table 8 provides high-order coefficients A4, A6, A8, A10, A12, A14, A16, A18, and A20 applied to surfaces S1, S3, S4, S5, and S6 in Embodiment 3.

TABLE 8

| Surface | | | | | |
|---|---|---|---|---|---|
| number | A4 | A6 | A8 | A10 | A12 |
| S1 | −5.2423E−06 | 1.0970E−07 | −5.7731E−10 | 1.2016E−12 | 8.0668E−16 |
| S3 | 2.1871E−05 | −1.1778E−07 | 1.3984E−10 | 2.9734E−13 | −7.8221E−16 |
| S4 | 2.3779E−06 | −1.2946E−08 | −3.7600E−11 | 2.2748E−13 | −2.8388E−16 |
| S5 | −1.4218E−04 | 6.0769E−07 | 7.4849E−10 | −8.1296E−12 | 1.2188E−14 |
| S6 | −1.3926E−04 | 8.1291E−07 | −6.4125E−10 | −5.8311E−12 | 1.2004E−14 |

| Surface | | | | |
|---|---|---|---|---|
| number | A14 | A16 | A18 | A20 |
| S1 | −7.6665E−18 | 8.3756E−21 | 0.0000E+00 | 0.0000E+00 |
| S3 | 1.6969E−19 | 8.1019E−22 | 0.0000E+00 | 0.0000E+00 |
| S4 | −1.2617E−19 | 4.5001E−22 | 0.0000E+00 | 0.0000E+00 |
| S5 | 1.8304E−18 | −1.1284E−20 | 0.0000E+00 | 0.0000E+00 |
| S6 | −1.9009E−18 | −1.7955E−21 | 0.0000E+00 | 0.0000E+00 |

In the embodiment, the visual system has the first state (as shown in FIG. 9) and the second state (as shown in FIG. 11). W1, W2, and W3 are variables, and are able to vary with the state of the visual system.

Table 9 shows values of W1, W2, and W3 in different states of the visual system in Embodiment 3.

TABLE 9

| Status | W1(mm) | W2(mm) | W3(mm) |
|---|---|---|---|
| First state | 500.0000 | 2.9405 | 1.0901 |
| Second state | −200.0000 | 0.5000 | 3.5306 |

FIG. 10 shows an MTF curve of a visual system in a first state according to Embodiment 3. FIG. 12 shows an MTF curve of a visual system in a second state according to Embodiment 3. According to FIG. 10 and FIG. 12, it is seen that, the visual system provided in Embodiment 3 in the first state and the second state is able to achieve good imaging quality.

### Embodiment 4

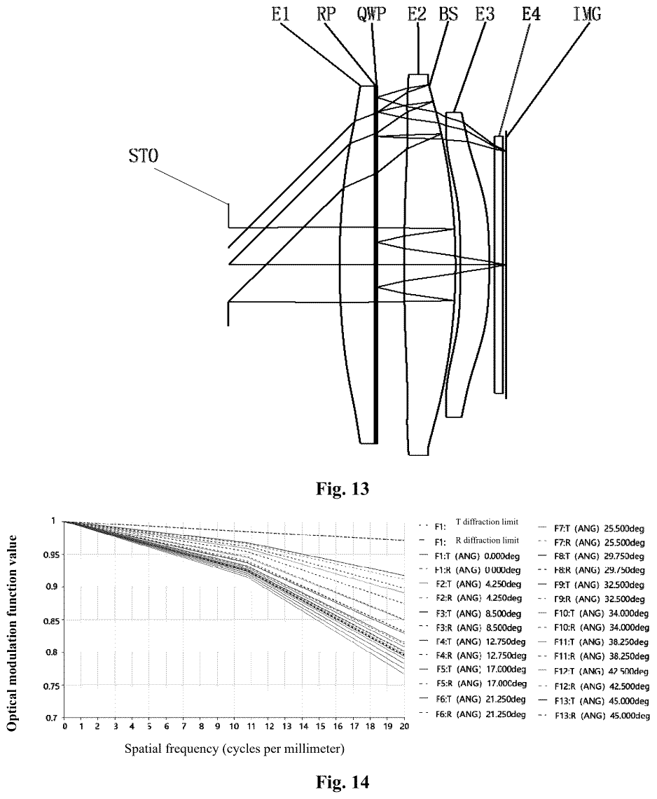

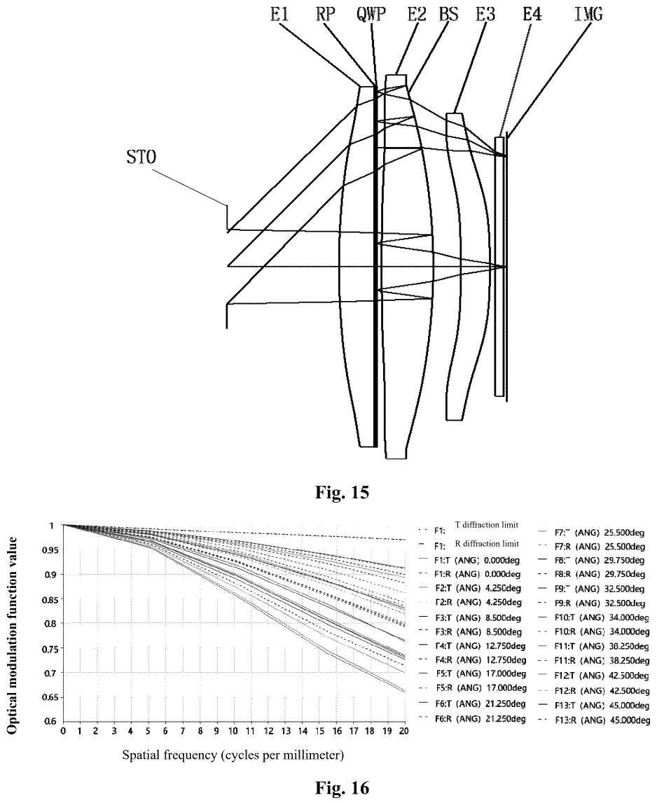

A visual system in Embodiment 4 of the disclosure is described below with reference to FIG. 13, FIG. 14, FIG. 15, and FIG. 16.

As shown in FIG. 13 and FIG. 15, the visual system includes a first lens E1, a reflective polarizing element RP, a quarter-wave plate QWP, a second lens E2, a partially-reflective element BS, and a third lens E3, which are sequentially arranged from a first side to a second side along an optical axis. A diaphragm STO is located on an object side of the first lens E1. In the embodiment, the first side refers to a human eye side, and the second side refers to a display screen side.

The first lens E1 has a positive refractive power, with a first side surface S1 thereof is a convex surface and a second side surface S2 thereof is a flat surface. The second lens E2 has a positive refractive power, with a first side surface S3 thereof is a convex surface, and a second side surface S4 thereof is a convex surface. The third lens E3 has a positive refractive power, with a first side surface S5 thereof is a flat surface, and a second side surface S6 thereof is a convex surface. The reflective polarizing element RP and the quarter-wave plate QWP are attached to the second side surface S2 of the first lens E1. The partially-reflective element BS is attached to the second side surface S4 of the second lens E2. It is to be noted that, surfaces S1, S2, S3, S4, S5 and S6 are not shown in FIG. 13 and FIG. 15.

In the embodiment, the second side of the visual system is provided with an imaging surface IMG, and a display screen is, for example, provided on the imaging surface IMG. As shown in FIG. 13 and FIG. 15, image light from the imaging surface IMG sequentially passes through the third lens E3, the second lens E2, and the quarter-wave plate QWP, reaches the reflective polarizing element RP, and then is subjected to a first reflection at the reflective polarizing element RP. The first reflected light passes through the quarter-wave plate QWP and the second lens E2 and reaches the partially-reflective element BS located on the second side surface of the second lens, and then is subjected to a second reflection at the partially-reflective element BS. The second reflected light sequentially passes through the second lens E2, the quarter-wave plate QWP, the reflective polarizing element RP, the first lens E1 to the diaphragm, and finally images at the predetermined position. For example, the light of the visual system that is reflected twice is finally projected to the pupil of a user. A protective glass E4 is also arranged between the imaging surface IMG and the third lens E3.

Table 10 shows a basic structure parameter table of the visual system in Embodiment 4; and radius of curvature and thickness/distance are all millimeters (mm). The image light from the imaging surface IMG passes the elements according to a sequence from a serial number 17 to a serial number 1, and is finally projected to the pupil of the user.

TABLE 10

| | | | | | Material | | | |
|---|---|---|---|---|---|---|---|---|
| Serial | | Surface | Radius of | Thickness/ | Refractive | Abbe | Refraction/ | Conic |
| number | Element | type | curvature | distance | index | number | Reflection | coefficient |
| | | Spherical | Infinite | W1 | | | Refraction | |
| 1 | Diaphragm | Spherical | Infinite | 12.0000 | | | Refraction | |
| 2 | First lens | Aspheric | 74.1303 | 3.8331 | 1.548 | 56.30 | Refraction | 14.7980 |
| 3 | Reflective | Spherical | Infinite | 0.1180 | 1.495 | 57.47 | Refraction | |
| | polarizing | | | | | | | |
| | element | | | | | | | |
| 4 | Quarter- | Spherical | Infinite | 0.1340 | 1.495 | 57.47 | Refraction | |
| | wave plate; | | | | | | | |
| 5 | | Spherical | Infinite | W2 | | | Refraction | |
| 6 | Second lens | Aspheric | 658.3370 | 5.5429 | 1.548 | 56.30 | Refraction | 99.0000 |
| 7 | Partially- | Aspheric | −61.8099 | −5.5429 | 1.548 | 56.30 | Reflection | −7.5857 |
| | reflective | | | | | | | |
| | element | | | | | | | |
| 8 | | Aspheric | 658.3370 | −W2 | | | Refraction | 99.0000 |
| 9 | | Spherical | Infinite | −0.1340 | 1.495 | 57.47 | Refraction | |
| 10 | Reflective | Spherical | Infinite | 0.1340 | 1.495 | 57.47 | Reflection | |
| | polarizing | | | | | | | |
| | element | | | | | | | |
| 11 | | Spherical | Infinite | W2 | | | Refraction | |
| 12 | Second lens | Aspheric | 658.3370 | 5.5429 | 1.548 | 56.30 | Refraction | 99.0000 |
| 13 | | Aspheric | −61.8099 | W3 | | | Refraction | −7.5857 |
| 14 | Third lens | Aspheric | Infinite | 3.1441 | 1.548 | 56.30 | Refraction | −99.0000 |
| 15 | | Aspheric | −109.9276 | 0.6000 | | | Refraction | 40.8966 |
| 16 | Protective | Spherical | Infinite | 0.9000 | 1.519 | 64.17 | Refraction | |
| | glass | | | | | | | |
| 17 | | Spherical | Infinite | 0.3000 | | | Refraction | |
| | Imaging | Spherical | Infinite | 0.0000 | | | Refraction | |
| | surface | | | | | | | |

In the embodiment, the first side surface S1 of the first lens E1, the first side surface S3 and the second side surface S4 of the second lens E2, and the first side surface S5 and the second side surface S6 of the third lens E3 are all aspheric surfaces. Table 11 provides high-order coefficients A4, A6, A8, A10, A12, A14, A16, A18, and A20 applied to surfaces S1, S3, S4, S5, and S6 in Embodiment 4.

TABLE 11

| Surface | | | | | | | | | |
|---|---|---|---|---|---|---|---|---|---|
| number | A4 | A6 | A8 | A10 | A12 | A14 | A16 | A18 | A20 |
| S1 | −1.9124E−05 | 1.7343E−07 | −9.2758E−10 | 2.3573E−12 | −2.9395E−15 | 0.0000E+00 | 0.0000E+00 | 0.0000E+00 | 0.0000E+00 |
| S3 | 2.7644E−05 | −1.7094E−07 | 2.3086E−10 | 3.1010E−13 | −5.8570E−16 | 0.0000E+00 | 0.0000E+00 | 0.0000E+00 | 0.0000E+00 |
| S4 | 2.6785E−06 | −1.8312E−08 | −4.0205E−11 | 2.5114E−13 | −2.4473E−16 | 0.0000E+00 | 0.0000E+00 | 0.0000E+00 | 0.0000E+00 |
| S5 | −1.8210E−04 | 1.1586E−06 | −2.5603E−09 | 1.9931E−12 | −8.3941E−16 | 0.0000E+00 | 0.0000E+00 | 0.0000E+00 | 0.0000E+00 |
| S6 | −1.6743E−04 | 9.2700E−07 | −2.3992E−10 | −8.4016E−12 | 1.6111E−14 | 0.0000E+00 | 0.0000E+00 | 0.0000E+00 | 0.0000E+00 |

In the embodiment, the visual system has the first state (as shown in FIG. 13) and the second state (as shown in FIG. 15). W1, W2, and W3 are variables, and are able to vary with the state of the visual system.

Table 12 shows values of W1, W2, and W3 in different states of the visual system in Embodiment 4.

TABLE 12

| Status | W1(mm) | W2(mm) | W3(mm) |
|---|---|---|---|
| First state | 500.0000 | 2.9280 | 0.5000 |
| Second state | −200.0000 | 0.5000 | 2.9280 |

FIG. 14 shows an MTF curve of a visual system in a first state according to Embodiment 4. FIG. 16 shows an MTF curve of a visual system in a second state according to Embodiment 4. According to FIG. 14 and FIG. 16, it is seen that, the visual system provided in Embodiment 4 in the first state and the second state is able to achieve good imaging quality.

Table 13 provides basic parameters of each of Embodiments 1-4, for example, values of fm, fn, f1, f2, f3, fg, EPD, TD, Af.

TABLE 13

Embodiment

| Parameter | 1 | 2 | 3 | 4 |
|---|---|---|---|---|
| fm (mm) | 16.70 | 17.30 | 17.14 | 17.32 |
| fn (mm) | 15.51 | 16.06 | 15.60 | 16.14 |
| f1(mm) | 114.20 | 122.93 | 162.26 | 135.28 |
| f2(mm) | 99.72 | 106.75 | 108.21 | 103.40 |
| f3(mm) | 123.78 | 113.90 | 49.59 | 200.61 |
| fg (mm) | 114.20 | 122.93 | 162.26 | 135.28 |
| EPD(mm) | 8.00 | 8.00 | 8.00 | 8.00 |
| TD(mm) | 17.00 | 17.00 | 17.00 | 16.20 |
| Δf (mm) | 1.18 | 1.24 | 1.54 | 1.18 |

Table 14 provides values of conditional expressions in each of Embodiment 1-4.

TABLE 14

| | Embodiment | | | |
|---|---|---|---|---|
| Conditional expression | 1 | 2 | 3 | 4 |
| fg/f2 | 1.15 | 1.15 | 1.50 | 1.31 |
| ΔL/Δf | 1.85 | 1.84 | 1.58 | 2.05 |
| TD/ΔL | 7.76 | 7.48 | 6.97 | 6.67 |
| L13 | 8.64 | 9.29 | 9.43 | 9.22 |
| EPD/Δf | 6.76 | 6.46 | 5.19 | 6.77 |
| ΔL | 2.19 | 2.27 | 2.44 | 2.43 |
| fm/CT2 | 3.21 | 3.00 | 3.33 | 3.12 |
| (CT1 + CTR + CTQ)/T12n | 6.39 | 6.13 | 5.12 | 5.43 |
| CT3/T23n | 1.41 | 1.21 | 1.12 | 1.07 |
| f1/fn | 7.36 | 7.65 | 10.40 | 8.38 |
| f3/R6 | −2.58 | −2.51 | −1.83 | −1.82 |
| fm/T12m | 5.68 | 5.72 | 5.37 | 5.45 |
| R4/(T23m + T23n) | −18.65 | −18.27 | −12.83 | −18.03 |
| f2/(fm + fn) | 3.10 | 3.20 | 3.30 | 3.09 |
| R4/CT2 | −11.45 | −10.39 | −11.52 | −11.15 |

The disclosure further provides an optical apparatus. The optical apparatus is an independent projection device such as a projector, or is also a projection module that is integrated on a mobile electronic device such as a virtual reality device and/or augmented reality device, etc. The optical apparatus is provided with the visual system described above.

The above descriptions are merely the specific embodiments and the used technical principles of the disclosure. It should be understood by those skilled in the art that the invented scope involved in the disclosure is not limited to the technical solution formed by a particular combination of the above technical features, but should also cover other technical solutions formed by any combination of the above technical features or their equivalent features without departing from the above invented concept, for example, the technical solutions formed by interchanging the above features with (but not limited to) technical features with similar functions disclosed in the disclosure.

What is claimed is:

1. A visual system, sequentially comprising from a first side to a second side along an optical axis:
a first lens with a positive refractive power, wherein a first side surface thereof is a convex surface and a second side surface thereof is a flat surface;
a reflective polarizing element;
a quarter-wave plate;
a second lens with a positive refractive power, wherein a second side surface thereof is a convex surface;
a partially-reflective element; and
a third lens with a positive refractive power, wherein a second side surface thereof is a convex surface;
a position of the first lens on the optical axis relative to an imaging surface of the second side is fixed, and a distance of the second lens on the optical axis relative to the first lens is adjustable;
there are three lenses with refractive powers in the visual system; and
the visual system satisfies: 1.15≤fg/f2≤1.50 and 1.55<ΔL/Δf<2.1, where fg is a combined focal length of the first lens, the reflective polarizing element and the quarter-wave plate, f2 is an effective focal length of the second lens, ΔL is a movable distance of the second lens when the visual system is switched between a first state and a second state, and Δf is a difference between a total effective focal length when the visual system is in the first state and a total effective focal length when the visual system is in the second state.

2. The visual system according to claim 1, wherein the visual system further satisfies:
$$6.65 < TD / Δ L < 7.8 ,$$
where TD is an on-axis distance from the first side surface of the first lens to the second side surface of the third lens, and ΔL is the movable distance of the second lens when the visual system is switched between the first state and the second state.

3. The visual system according to claim 1, wherein the visual system further satisfies:
$$8.64 mm \leq L 13 \leq 9.43 mm ,$$
where L13 is an on-axis distance from the second side surface of the first lens to a first side surface of the third lens.

4. The visual system according to claim 1, wherein the visual system further satisfies:
$$5.15 < EPD / Δ f < 6.8 ,$$
where EPD is an entrance pupil diameter of the visual system, and Δf is the difference between the total effective focal length when the visual system is in the first state and the total effective focal length when the visual system is in the second state.

5. The visual system according to claim 1, wherein the visual system further satisfies:
$$2.15 mm < Δ L < 2.45 mm ,$$
where ΔL is the movable distance of the second lens when the visual system is switched between the first state and the second state.

6. The visual system according to claim 1, wherein the visual system further satisfies:
$$3. \leq fm / CT 2 \leq 3.33 ,$$
where fm is the total effective focal length when the visual system is in the first state, and CT2 is a center thickness of the second lens on the optical axis.

7. The visual system according to claim 1, wherein the visual system further satisfies:
$$5.1 < ( CT 1 + CTR + CTQ ) / T 12 n < 6.4 ,$$
where CT1 is a center thickness of the first lens on the optical axis, CTR is a center thickness of the reflective polarizing element on the optical axis, CTQ is a center thickness of the quarter-wave plate on the optical axis, and T12n is an on-axis distance from the second side surface of the first lens to a first side surface of the second lens when the visual system is in the second state.

8. The visual system according to claim 1, wherein the visual system further satisfies:
$$1. 07 \leq CT 3 / T 23 n \leq 1.41 ,$$
where CT3 is a center thickness of the third lens on the optical axis, and T23n is an on-axis distance from the second side surface of the second lens to a first side surface of the third lens when the visual system is in the second state.

9. The visual system according to claim 1, wherein the visual system further satisfies:
$$7.36 \leq f 1 / fn \leq 10.4 ,$$
where f1 is an effective focal length of the first lens, and fn is the total effective focal length when the visual system is in the second state.

10. The visual system according to claim 1, wherein the visual system further satisfies:
$$- 2.6 < f 3 / R 6 < - 1.8 ,$$
where f3 is an effective focal length of the third lens, and R6 is a radius of curvature of the second side surface of the third lens.

11. The visual system according to claim 1, wherein the visual system further satisfies:
$$5.35 < fm / T 12 m < 5.75 ,$$
where fm is the total effective focal length when the visual system is in the first state, and T12m is an on-axis distance from the second side surface of the first lens to a first side surface of the second lens when the visual system is in the first state.

12. The visual system according to claim 1, wherein the visual system further satisfies:
$$- 18.65 \leq R 4 / ( T 23 m + T 23 n ) \leq - 12.83 ,$$
where R4 is a radius of curvature of the second side surface of the second lens, T23m is an on-axis distance from the second side surface of the second lens to a first side surface of the third lens when the visual system is in the first state, and T23n is an on-axis distance from the second side surface of the second lens to the first side surface of the third lens when the visual system is in the second state.

13. The visual system according to claim 1, wherein the visual system further satisfies:
$$3.09 \leq f 2 / ( fm + fn ) \leq 3.30 ,$$
where f2 is an effective focal length of the second lens, fm is the total effective focal length when the visual system is in the first state, and fn is the total effective focal length when the visual system is in the second state.

14. The visual system according to claim 1, wherein the visual system further satisfies:
$$- 11.52 \leq R 4 / CT 2 \leq - 10.39 ,$$
where R4 is a radius of curvature of the second side surface of the second lens, and CT2 is a center thickness of the second lens on the optical axis.
